(19) United States
(12) Patent Application Publication
(10) Pub. No.: US 2026/0222423 A1
(43) Pub. Date: Jul. 30, 2026

(54) SYSTEMS AND METHODS FOR AUTOMATIC DISTRIBUTED SECURITY LOGGING

(71) Applicant: Wells Fargo Bank, N.A., San Francisco, CA (US)

(72) Inventor: Rameshchandra Bhaskar Ketharaju, Hyderabad (IN)

(21) Appl. No.: 19/041,616

(22) Filed: Jan. 30, 2025

(51) Int. Cl. H04L 9/40

(52) U.S. Cl. CPC H04L 63/1416; H04L 63/1425

(57) ABSTRACT

Systems and methods are disclosed herein for automatic distributed security logging. An example method includes detecting, by security agent circuitry, a security event related to a computer network, and recording, by logging circuitry, an indication of the security event to a storage element belonging to the computer network. The example method also includes determining, by the security agent circuitry, an impact level of the security event, and processing, by ledger circuitry, the security event based on the impact level to produce a ledger security event. The example method also includes selecting, by the ledger circuitry, a number of distributed ledger nodes of a distributed ledger for consensus based on the impact level, and broadcasting, by the ledger circuitry, an indication of the ledger security event to a set of distributed ledger nodes numbering at least the selected number of distributed ledger nodes.

### BACKGROUND

Distributed ledger technology, capable of processing transactions across a network without a single point of failure, has grown rapidly in recent years in terms of popularity and technological advancement. Distributed ledgers offer advantages in scalability and security, while providing a tamper-proof method for keeping records.

### BRIEF SUMMARY

Security threats may evolve quickly and involve multiple organizations simultaneously across the globe. There is a need to share information throughout various networks of organizations to rapidly respond to and mitigate threats from cybersecurity attacks. At the same time, a single point of failure or central clearinghouse presents a point of vulnerability, should it become compromised or otherwise not trusted by networks and/or organizations. Additionally, organizational and administrative challenges may make it difficult to establish a central point of contact for distributing real-time security information.

In contrast to traditional methods, example embodiment disclosed herein provide a global federated distributed ledger log for cybersecurity agent programs. Example embodiments may include a system of interconnected software agents that are each responsible for monitoring threats within a particular network or other organizational unit. The agents are able to add records to a global distributed ledger that is maintained in a decentralized manner by the various participating organizational units. The distributed ledger provides a platform for multiple entities to maintain redundant copies of the cybersecurity record, adding data that is shared across the ledger without a centralized point of failure. Individual nodes may use various consensus algorithms to determine the consensus contents of the ledger, which may include dynamic consensus models that scale based on properties of the data being shared. In a blockchain, a type of distributed ledger, growing lists of records are recorded as blocks linked by hashes for security, providing one example approach to creating an ever-growing record that is verifiable and highly resistant to tampering.

Example embodiments may include a network of machine learning (ML) or artificial intelligence (AI) based security agent programs for real-time monitoring in combination with the distributed ledger system, which receives records of activity from the security agent programs. Example systems may also include a front end for user interaction. The front end may include a dashboard for administrators to manage the local AI agent. The dashboard may allow administrators to start or stop the service, control how much and what types of log data are reported to the distributed ledger, and review locally logged events. The dashboard may also interface with the distributed ledger, allowing administrators to retrieve log data and manage the functionality of distributed ledger nodes. Administrators may be able to view the status of the distributed ledger and view log data from the dashboard. Analysis and trends spotted in the global distributed ledger logs may also be automatically displayed on the dashboard as alerts. The dashboard may allow administrators to configure the system to automatically take certain actions based on events seen on global logs.

The AI/ML-based security agent programs may be applications that run in the background and monitor network traffic, application logs, authentication attempts, and/or other such activities. The agents may include an AI-based classifier model that ingests the network traffic and other data, then labels the data as either relevant to be forwarded to the distributed ledger or not relevant. The classifier model may be trained using historical log data that is labeled in the same manner. In some configurations, the classifier model may perform other analysis tasks on the recorded data, drawing higher-level inferences based on the raw data collected. In another embodiment, the classifier may be implemented using a rules-based approach, avoiding the use of AI entirely. Either the AI-based classifier or the rules-based classifier may detect patterns in the data associated with suspicious activity.

Additionally, the security agent may receive data from the distributed ledger as a supplemental input. The distributed ledger data may be retrieved via a distributed ledger agent and ingested by the AI agent for further analysis. The distributed ledger data may enhance or complement the AI agent's ability to find patterns in the local log data. For example, suspicious activity from the distributed ledger logs may lower the threshold for considering local activity at or around the same timestamp as potentially suspicious. Conversely, activity that is just above the threshold of being deemed suspicious at the local level may, when coupled with the absence of any correlated activity from global logs, be downgraded to a classification of not suspicious.

The distributed ledger may be implemented by a network of interconnected nodes throughout the geographic range of the network. In some implementations, devices hosting the security agent devices may double as the nodes of the distributed ledger network. The distributed ledger may be implemented, for example, as a blockchain, where each security agent entity uploads a new block to the distributed ledger with a hash of previous blocks, making the record highly resistant to tampering. Distributed ledger nodes may use any of the consensus-building mechanisms available for distributed ledgers, such as proof-of work or proof of stake, and the distributed ledgers may be permissioned or permissionless. Records in the distributed ledger include selective logs from the security agents of the global network. The AI agent logs may be redacted to remove sensitive data from internal networks of member organizations. In some implementations, the distributed ledger may be a private network, where only approved members are allowed to access records.

The distributed ledger may further be used for training AI/ML based security agents. Over time, the distributed ledger will acquire a curated historical record of cybersecurity-related events. The records may be automatically retrieved by security agent program instances to use for additional training. In some embodiments, labeling of the log datasets on the distributed ledger may be provided, to be used for training AI-based security agents. The labels for the distributed ledger datasets may be provided in separate blocks on a blockchain or a sidechain with references to the main blockchain. In this way, entities may provide labeled datasets for retrieval without contaminating the main ledger with data labels that may later go out of date or otherwise be superseded. The training datasets for security agents may use recency/seasonality-based training to improve the model's effectiveness.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for automatic distributed security logging in accordance with some example embodiments described herein.

FIG. 2 illustrates a schematic block diagram of example circuitry embodying an automatic distributed security logging system that may perform various operations in accordance with some example embodiments described herein.

FIG. 3 illustrates an example flowchart for automatic distributed security logging, in accordance with some example embodiments described herein.

FIG. 4A and FIG. 4B illustrate additional example flowcharts for automatic distributed security logging, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “block” may refer to a data structure associated with a blockchain, a type of distributed ledger. For example, a block may comprise a model definition data structure, a block header data structure, a technical data structure, a business data structure, an operational data structure, a next block information data structure, any other suitable electronic information or data structure associated therewith (including, but not limited to, links or pointers), or any combination thereof. A block header data structure may comprise a current block hash value data structure, a previous block hash value data structure, a next block hash value data structure, a Merkle root hash value data structure, a nonce value data structure, any other suitable electronic information or data structure associated therewith (including, but not limited to, links or pointers), or any combination thereof.

The term “blockchain” may refer to a digital ledger comprising a growing list of blocks. For example, a blockchain may comprise a plurality of blocks, any other suitable electronic information or data structure associated therewith (including, but not limited to, links or pointers), or any combination thereof.

The term “node device” or “node” may refer generally to a computing device, such as a server device, client device, a database server device, a data storage device, or a blockchain data storage device that stores one or more portions of a blockchain or other distributed ledger. For example, a node device may comprise a server device, a client device, a database, a database server device, any other suitable device or data structure associated therewith (including, but not limited to, links or pointers), or any combination thereof.

The term “sidechain” refers to a secondary blockchain that operates in parallel to a primary blockchain. The sidechain may set different standards for consensus, record-keeping, or other properties of the sidechain that are distinct from those of the primary blockchain. For example, a sidechain may have a lower transaction cost and faster transaction times due to a less difficult consensus requirement, or faster block times, trading off faster transactions for reduced security. Sidechains may also be permissioned, allowing an entity or consortium to manage a sidechain while still maintaining a connection to the primary blockchain. Sidechains also permit assets on the sidechain to move to and from the main chain when needed, typically by means of a two-way bridge between the two blockchains, where predetermined rules for exchange between the two blockchains are established.

### System Architecture

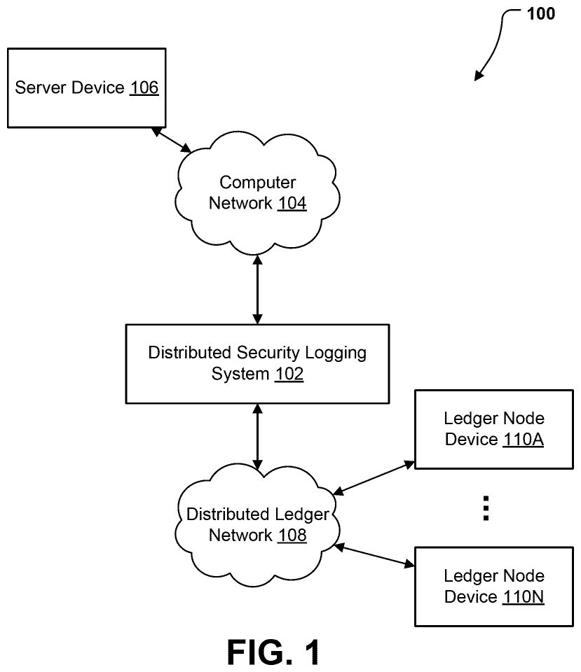

Example embodiments described herein may be implemented using any of a variety of computing devices or servers. To this end, FIG. 1 illustrates an example environment 100 within which various embodiments may operate. As illustrated, a distributed security logging system 102 may receive and/or transmit information via communications network 104 (e.g., the Internet) with any number of other devices, such as server device 106.

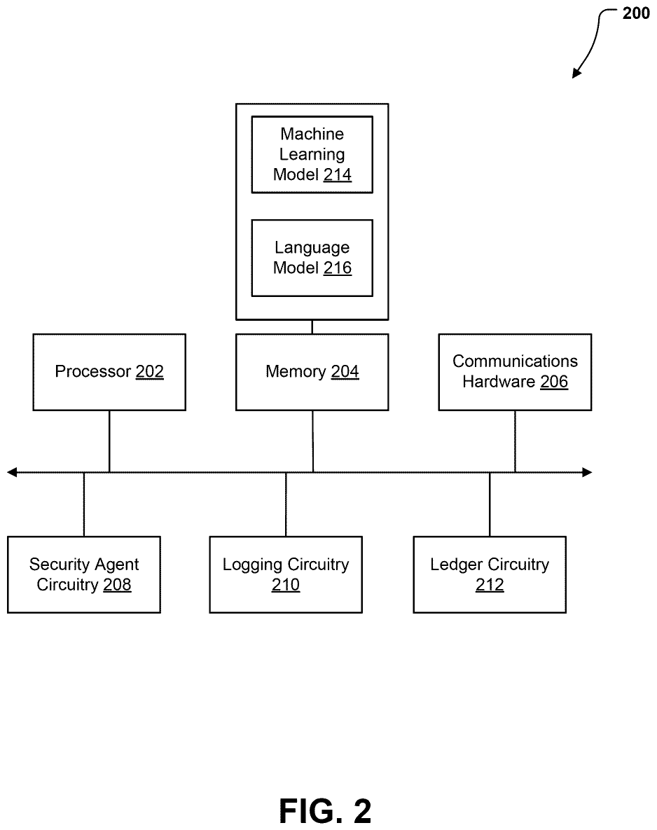

The distributed security logging system 102 may be implemented as one or more computing devices or servers, which may be composed of a series of components. Particular components of the distributed security logging system 102 are described in greater detail below with reference to apparatus 200 in connection with FIG. 2.

The server device 106 may be embodied by any computing devices known in the art. The server device 106 need not be an independent device but may be embodied as one or more peripheral devices communicatively coupled to other computing devices.

The distributed ledger network 108 is a collection of networked node devices of a blockchain, which may be permissionless (public), or permissioned (private). The distributed ledger network 108 may use any distributed ledger or blockchain technology that is capable of creating and exchanging blockchain tokens or NFTs. In some embodiments, the distributed ledger network 108 may allow for Turing-complete scripting of contracts, known also as smart contracts, to be executed on the blockchain. The distributed ledger network 108 may be related to other distributed ledgers and/or blockchain networks not pictured here. For example, the distributed ledger network 108 may be a sidechain of another distributed ledger or blockchain network, or another network (not shown) may form a sidechain of the distributed ledger network 108. The nodes may be embodied by ledger node device 110A through ledger node device 108N, which may be specialized node devices, or may be embodied by any computing devices or server devices known in the art. In some embodiments the distributed security logging system 102 itself may be a node of the distributed ledger network 108, or the distributed security logging system 102 may be external to the distributed ledger.

### Example Implementing Apparatuses

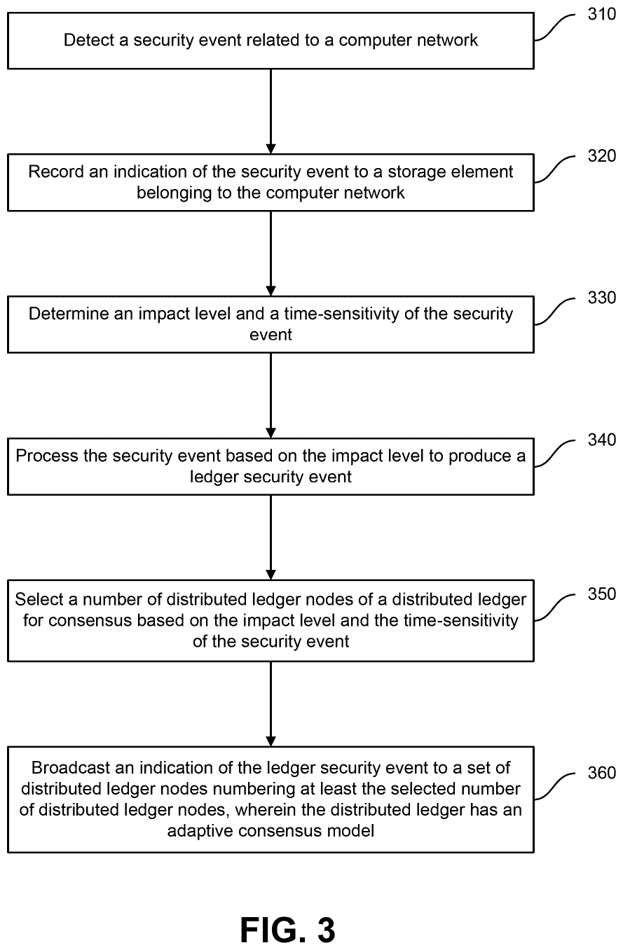

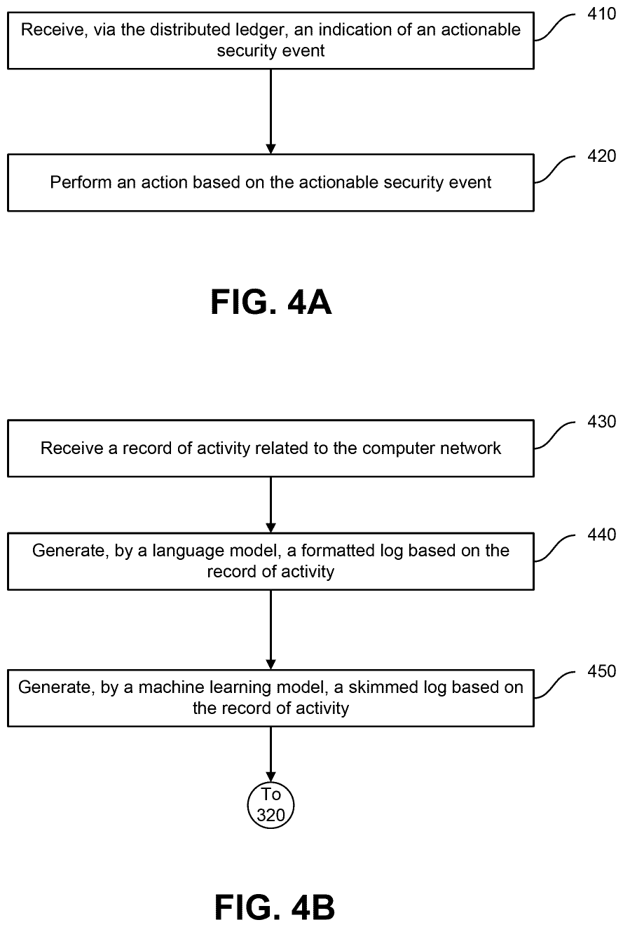

The distributed security logging system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-4B. As illustrated in FIG. 2, the apparatus 200 may include processor 202, memory 204, communications hardware 206, security agent circuitry 208, logging circuitry 210, and ledger circuitry 212 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a security agent circuitry 208 that deploys security agents that may monitor, detect, log, screen, and otherwise record security events related to a server device and/or computer network. The security agent circuitry 208 may utilize processor 202, memory 204, or any other hardware component included in the apparatus 200 to perform these operations, as described in connection with FIGS. 3-4B below. The security agent circuitry 208 may further utilize communications hardware 206 to gather data from a variety of sources (e.g., server device 106, shown in FIG. 1), and/or exchange data with a user, and in some embodiments may utilize processor 202 and/or memory 204 to manage security agents and detect security events.

In addition, the apparatus 200 further comprises a logging circuitry 210 that compiles logs and records information suitable for distribution on a distributed ledger. The logging circuitry 210 may utilize processor 202, memory 204, or any other hardware component included in the apparatus 200 to perform these operations, as described in connection with FIGS. 3-4B below. The logging circuitry 210 may further utilize communications hardware 206 to gather data from a variety of sources (e.g., server device 106, shown in FIG. 1), and/or exchange data with a user, and in some embodiments may utilize processor 202 and/or memory 204 to perform logging functions.

In addition, the apparatus 200 further comprises a ledger circuitry 212 that performs functions interacting with a distributed ledger such as selecting ledger nodes, preparing messages to encode into ledger blocks, broadcasting messages to the distributed ledger, and receiving information from the distributed ledger. The ledger circuitry 212 may utilize processor 202, memory 204, or any other hardware component included in the apparatus 200 to perform these operations, as described in connection with FIGS. 3-4B below. The ledger circuitry 212 may further utilize communications hardware 206 to gather data from a variety of sources (e.g., server device 106, shown in FIG. 1), and/or exchange data with a user, and in some embodiments may utilize processor 202 and/or memory 204 to interact with the distributed ledger.

Although components 202-212 are described in part using functional language, it will be understood that the particular implementations necessarily include the use of particular hardware. It should also be understood that certain of these components 202-212 may include similar or common hardware. For example, the security agent circuitry 208, logging circuitry 210, and ledger circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. While the term “circuitry” should be understood broadly to include hardware, in some embodiments, the term “circuitry” may in addition refer to software instructions that configure the hardware components of the apparatus 200 to perform the various functions described herein.

Although the security agent circuitry 208, logging circuitry 210, and ledger circuitry 212 may leverage processor 202, memory 204, or communications hardware 206 as described above, it will be understood that any of security agent circuitry 208, logging circuitry 210, or ledger circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that security agent circuitry 208, logging circuitry 210, and ledger circuitry 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

In some embodiments, memory 204 may store one or more trained models that may be used by circuitry of apparatus 200 for performing example methods disclosed herein. For example, memory 204 may store parameters for a machine learning (ML) or artificial intelligence (AI) model that, when interpreted and applied with the appropriate circuitry and/or computer program instructions, may perform various ML and AI functions. It will be understood that the apparatus 200 may include specialized circuitry for the use of the stored models and/or model parameters in memory 204, and that applying the stored model parameters with the specialized circuitry of apparatus 200, or loading appropriate instructions for processor 202 in combination with the stored model parameters produces a special-purpose machine comprising the means for performing the example methods involving ML and/or AI models disclosed herein.

Memory 204 may store a machine learning model 214 that may generate a skimmed log based on a record of activity. The skimmed log may be a selection of events in a larger log that provide an indication of a security event. Accordingly, the machine learning model 214 may be a model trained for detecting anomalies in a security log. The machine learning model 214 may be any ML and/or AI model known in the art, including neural networks, decision trees, support vector machines, transformers, various types or variations of neural networks including deep neural networks, autoencoders, convolutional neural networks, recurrent neural networks, and/or the like. The machine learning model 214 may be trained and configured to identify anomalous and/or high-risk activity related to security based on a log of security-related events. For example, the machine learning model 214 may output a score indicating the degree of confidence that a log or a section of a log includes anomalies or high-risk activity.

In some embodiments, the machine learning model may additionally include components, layers, or sub-models dedicated to interpreting natural language that may process the log file to produce an intermediate data form and/or connect directly subsequent layers or components of the first machine learning model.

Memory 204 may store a language model 216 that may generate a formatted log based on a record of activity. The language model 216 may be any ML and/or AI model known in the art that is able to process and generate language-based data. For example, the language model 216 may be a transformer or any other approach based on attention mechanisms, recurrent neural network, neural network using long short-term memory, convolutional neural network, Markov model, or any combination or variation thereof. The stored parameters representing training of the language model 216 may constitute training like a typical language model for understanding general language input and output, or may use specialized training for understanding log files (e.g., the logs recorded by logging circuitry 210). In any case, the language model 216 may include training or fine-tuning to process log files related to network security in various formats and, optionally, to detect high-risk activity and/or anomalous behavior (e.g., in support of, in addition to, or alternatively to machine learning model 214).

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

Turning to FIGS. 3, 4A, and 4B, example flowcharts are illustrated that contain example operations implemented by example embodiments described herein. The operations illustrated in FIGS. 3-5 may, for example, be performed by the distributed security logging system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, security agent circuitry 208, logging circuitry 210, ledger circuitry 212, and/or any combination thereof. It will be understood that user interaction with the distributed security logging system 102 may occur directly via communications hardware 206 or may instead be facilitated by a separate server device 106, as shown in FIG. 1, and which may have similar or equivalent physical componentry facilitating such user interaction.

Turning first to FIG. 3, example operations are shown for automatic distributed security logging. As shown by operation 310, the apparatus 200 includes means, such as processor 202, memory 204, communications hardware 206, security agent circuitry 208, or the like, for detecting a security event related to a computer network. The security agent circuitry 208, as described previously, may deploy one or more security agents. The security agent circuitry 208 may further manage, collect telemetry, configure, provide updates, and otherwise manage the operation of the one or more security agents. The security agent may be software, specialized hardware, or a combination of hardware and software configure to monitor activities of a computing network, which may comprise, for example, server device 106. The security agent may use various techniques for telemetry and/or intelligence gathering for cybersecurity purposes, including intrusion detection systems (IDS) and/or intrusion prevention systems (IPS). The security agent may itself comprise IDS/IPS capabilities, and/or may coordinate and receive log information from such systems. The security agent may additionally provide network monitoring through other tools, such as network traffic analysis tools. The security agent may further collect and monitor log information or information from another record of activity from various network hardware, servers, and/or client devices. The security agent may also provide monitoring and analysis of user devices (e.g., endpoints) to produce a record of activity for any suspicious activity that may originate from within a network.

The security agent circuitry 208 may continuously receive information from the one or more security agents embedded in various computing networks and/or subnetworks. The security agent circuitry 208 may include models and/or rules-based systems (e.g., signature detection and/or anomaly-based detection) for detecting various security events related to the one or more computer networks in which the security agents may be embedded. For example, the security event may be a high likelihood of an intrusion or attack, a high likelihood of the loss or leakage of sensitive data, advance warning of a failure of hardware or other systems, and/or the like. Accordingly, the security agent circuitry 208 may maintain its own central logs (e.g., a record of activity) that compile information collected from the various security agents, and the central logs may remove redundant information, filter out irrelevant information (e.g., alarm filtering), add annotations based on additional data, and/or the like. In some examples, the security agent circuitry 208 may generate various intermediate log steps using one or more AI/ML models as shown in and described in connection with FIG. 4B.

As shown by operation 320, the apparatus 200 includes means, such as processor 202, memory 204, communications hardware 206, logging circuitry 210, or the like, for recording an indication of the security event to a storage element belonging to the computer network. The logging circuitry 210 may use memory 204 to locally store the indication of the security event, and/or the logging circuitry 210 may store the indication of the security event on an external device, such as a server or a network-attached storage device. In some embodiments, the processor 202 and/or logging circuitry 210 may perform various manipulations of the log prior to storage, including timestamping, formatting, augmenting, cleaning, annotating, and/or the like.

As shown by operation 330, the apparatus 200 includes means, such as processor 202, memory 204, security agent circuitry 208, or the like, for determining an impact level and a time sensitivity of the security event. The security agent circuitry 208, as discussed previously, may include capabilities for detecting security events amidst a background of routine network events (e.g., using signature-based detection or anomaly-based detection). In addition, security agent circuitry 208 may classify security events along one or more dimensions, such as time sensitivity and/or impact level. For example, the security agent circuitry 208 may provide a two-dimensional vector in a space where the first dimension relates to time sensitivity and the second dimension relates to impact level. In other examples, additional dimensions may be defined and/or different qualities may be assigned to each dimension. The security agent circuitry 208 may be configured to use a rules-based approach, AI/ML model, and/or a combination thereof to classify security events along the various dimensions. In some embodiments, the security agent circuitry 208 may produce the classification output using the same model used to detect the security events. For example, the security agent circuitry 208 may produce a vector classifying time sensitivity and impact of an event, and a threshold, which may be shaped in the two-dimensional space defined by the two factors, may be applied to determine if an event is identified as a security event. The time sensitivity, impact, and/or other factors may be expressed as numerical values, for example, as arbitrary scores, as normalized probabilities, and/or the like.

In some embodiments, security agent circuitry 208 may retrieve information stored on distributed ledger network 108 which may provide further training to machine learning model 214 or language model 216 and/or may modify various parameters of the operation of security agent circuitry 208. For example, retrieved distributed ledger data may enhance or complement the ability of a security agent to find patterns in local log data and identify a security event. Suspicious activity from the distributed ledger logs may lower the threshold for considering local activity at or around the same timestamp as potentially suspicious, for example, by adjusting the threshold for time sensitivity and/or impact factors. Conversely, activity that is near the threshold of being considered a security event at the local level coupled with the absence of any correlated activity from distributed ledger network 108 may be downgraded to a classification of not suspicious.

As shown by operation 340, the apparatus 200 includes means, such as processor 202, memory 204, ledger circuitry 212, or the like, for processing the security event based on the impact level to produce a ledger security event. The ledger security event may be a block in a blockchain, or any other data type that may be added to a distributed ledger (e.g., distributed ledger network 108). For example, a directed acyclic graph (DAG) ledger, hybrid ledger, other ledger technology may be used in addition to or alternatively to a linear blockchain structure. The ledger circuitry 212 may be configured to generate a record according to the type of distributed ledger technology used by distributed ledger network 108, including processing of various log information, diagnostic information, and/or the like to produce the ledger security event. The ledger security event may include directly copied excerpts from security logs and the like and/or may include derived data indicating the information conveyed by log entries. The ledger security event may further include hashes or other security information needed to process the ledger security event as an entry on the distributed ledger network 108. In some embodiments, the creation of the ledger security event may be influenced by the impact level of the security event described therein. The creation of the ledger security event may also be influenced by other factors (time sensitivity, etc.). For example, a greater level of detail may be included for security events deemed to be high-impact events, while fewer details may be preserved in the distributed ledger for lower-impact events.

As shown by operation 350, the apparatus 200 includes means, such as processor 202, memory 204, ledger circuitry 212, or the like, for selecting a quantity of distributed ledger nodes of a distributed ledger (e.g., one or more of ledger node device 110A-110N) belonging to distributed ledger network 108) for consensus based on the impact level and the time sensitivity of the security event. In some embodiments, the distributed ledger network 108 may operate using a dynamic consensus algorithm (e.g., a dynamic consensus model), wherein the quantity of distributed ledger nodes required to achieve consensus and therefore perform a transaction on the distributed ledger may be scaled based on the context of the transaction. In some embodiments, the ledger circuitry 212 may include or encapsulate a pre-determined algorithm for choosing the quantity of nodes required based on factors such as the impact level, time sensitivity, and/or the like. For example, a security event determined to have very high time sensitivity, but relatively low impact may require a smaller quantity of ledger node device 110A-110N to reach consensus. In contrast, a security event determined to have low time sensitivity, but high impact may require a greater quantity of ledger node device 110A-110N to reach consensus. The algorithm for determining the quantity of nodes required for consensus may itself be established and confirmed using consensus across the distributed ledger network 108 to increase resistance to tampering with the algorithm. The algorithm itself may be any rules-based and/or ML/AI-based algorithm for producing an output comprising a quantity of ledger nodes.

In some embodiments, the distributed ledger may be a permissioned distributed ledger. As such, access to the distributed ledger may be protected by requiring an authorized cryptographic key, password, or other means of establishing identity and authentication. In contrast to permissionless distributed ledgers which may be publicly accessible, only pre-approved participants may validate transactions and/or participate in consensus of the permissioned distributed ledger. Additionally, permissioned distributed ledgers may be accompanied by centralized governance, which may set various policies and regulations for the permissioned distributed ledger.

In some embodiments, a first ledger node from the set of distributed ledger nodes uses a first consensus mechanism, wherein a second ledger node from the set of distributed ledger nodes uses a second consensus mechanism. For example, a distributed ledger network 108 may include various node device 110A-110N where some devices may be legacy devices while others are newer devices. Legacy devices may not support or may not yet be upgraded to use a newer consensus mechanism, and so the distributed ledger network 108 may use a hybrid consensus mechanism. In some embodiments, the first ledger node and the second ledger nodes may belong to one or more sidechains, described below. The mixed or hybrid consensus mechanisms may additionally include the use of a dynamic consensus model (e.g., where the quantity of nodes needed for consensus may be adapted based on the content of the ledger records, as determined by a shared algorithm).

In some embodiments, the distributed ledger (e.g., distributed ledger network 108) is a blockchain, wherein the blockchain comprises a first sidechain and a second sidechain. In some embodiments, the first sidechain may comprise the first ledger node (e.g., ledger node device 110A), and the second sidechain mat comprise the second ledger node (e.g., ledger node device 110B). As described previously, a blockchain may be associated with a secondary blockchain called a sidechain that operates in parallel to the primary blockchain. The sidechain may set different standards for consensus, record-keeping, or other properties of the sidechain that are distinct from those of the primary blockchain. For example, a sidechain may have a lower transaction cost and faster transaction times due to a less difficult consensus requirement, or faster block times, trading off faster transactions for reduced security.

As shown by operation 360, the apparatus 200 includes means, such as processor 202, memory 204, communications hardware 206, ledger circuitry 212, or the like, for broadcasting an indication of the ledger security event to a set of distributed ledger nodes numbering at least the selected quantity of distributed ledger nodes. The transfer of the primary blockchain token is digitally signed by a token issuer. The communications hardware 206 may broadcast the transfer over distributed ledger network 108 to cause the transaction to take effect on the distributed ledger. Broadcasting the transaction may enable a plurality of ledger node device 110A-110N of the distributed ledger network 108 to validate the transaction and record it in a new ledger entry. The ledger circuitry 212 may digitally sign the broadcast using a local digital signature to prove that the entity broadcasting the security event is the same entity that is authorized to record and broadcast security event information. The digital signing of the broadcast may use a private key belonging to a security agent or the distributed security logging system 102. The broadcast may cause the ledger security event to be entered into the distributed ledger and/or blockchain of the distributed ledger network 108 produced in connection with operation 340 and described above.

Turning now to FIG. 4A, example operations are shown for performing an action based on a detected security event. As shown by operation 410, the apparatus 200 includes means, processor 202, memory 204, communications hardware 206, ledger circuitry 212, or the like, for receiving, via the distributed ledger, an indication of an actionable security event. In some embodiments, the ledger circuitry 212 may be configured to receive or download information from distributed ledger network 108, enabling circuitry of apparatus 200 to read information stored in the distributed ledger. For example, a remote device may detect a security event related to another network that indicates to a zero-day vulnerability. The indication of the zero-day vulnerability may be actionable in the sense that devices on a local computing network (e.g., server device 106) may require a security patch, downgrade, or other actions to protect against the zero-day vulnerability.

As shown by operation 420, the apparatus 200 includes means, processor 202, memory 204, communications hardware 206, or the like, for performing an action based on the actionable security event. Upon receiving indication of an actionable event from distributed ledger network 108, the apparatus 200 may cause one or more devices to respond to the actionable event. For example, devices may be reconfigured, taken offline, patched, or modified in other ways to respond to a security event such as an impending threat.

Turning now to FIG. 4B, example operations are shown for generating intermediate log formats using ML and based on a detected security event. As shown by operation 430, the apparatus 200 includes means, communications hardware 206, or the like, for receiving a record of activity related to the computer network. As described above in connection with operation 310, detecting the indication of the security event may comprise receiving log information or another record of activity from a security agent program, a networked computing device, network hardware, and/or the like.

As shown by operation 440, the apparatus 200 includes means, processor 202, memory 204, or the like, for generating, by machine learning model 214, a skimmed log based on the record of activity, wherein the indication of the security event comprises the skimmed log. In some embodiments, a pre-processing step may use machine learning model 214 to skim, filter, or otherwise reduce a log or record of activity that may contain an indication of a security event. For example, machine learning model 214 may be trained to detect log entries with a high likelihood of indicating a security event, and selection criteria may be applied to remove log entries falling below a pre-determined threshold likelihood.

As shown by operation 450, the apparatus 200 includes means, processor 202, memory 204, or the like, for generating, by language model 216, a formatted log based on the record of activity, wherein generating the skimmed log uses the formatted log as input to the machine learning model. For example, a prompt may be generated instructing language model 216 to provide the information contained in a record of activity (e.g., a log) in a particular format, where the format is different from the format of the original record of activity. As discussed previously, language model 216 may be a general-purpose language model, and may additionally or alternatively be trained or fine tuned for manipulation of log files. By using language model 216 to modify the formatting of a log, log files from disparate sources may be used together with ML models that may be trained using log files of a particular format.

As indicated in FIG. 4B, control may flow to operation 320 of FIG. 3 after completing operation 450. Accordingly logging circuitry 210 may utilize a skimmed and/or reformatted log may for recording an indication of a security event in a storage element. Additionally or alternatively, security agent circuitry 208 may determine the impact, time sensitivity, and/or other properties based on the skimmed and/or reformatted log.

### Conclusion

As described above, example embodiments provide methods and apparatuses that enable improved security logging by utilizing decentralized ledgers. By taking advantage of the decentralized nature and built-in tamper-proof, redundant architecture of the distributed ledger, example embodiments improve the collection and dissemination of security-related information to throughout an organization using techniques that scale to the time sensitive and/or high impact nature of various security events.

As these examples all illustrate, example embodiments contemplated herein provide technical solutions that solve real-world problems faced in the field of network security. While existing approaches use analysis of logs and other network information to detect and/or prevent intrusions, techniques to rapidly disseminate information while maintaining security are still needed. Example embodiments disclosed herein use an innovative approach with dynamic consensus mechanisms to gain the benefits of distributed ledger technology while minimizing the downsides associated with potentially costly static consensus, and so example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for automatic distributed security logging, the method comprising:
detecting, by security agent circuitry, a security event related to a computer network;
recording, by logging circuitry, an indication of the security event to a storage element belonging to the computer network;
determining, by the security agent circuitry, an impact level and a time sensitivity of the security event;
processing, by ledger circuitry, the security event based on the impact level to produce a ledger security event;
selecting, by the ledger circuitry, a quantity of distributed ledger nodes of a distributed ledger for consensus based on the impact level and the time sensitivity of the security event; and
broadcasting, by the ledger circuitry, an indication of the ledger security event to a set of distributed ledger nodes numbering at least the quantity of distributed ledger nodes, wherein the distributed ledger operates using a dynamic consensus model.

2. The method of claim 1, further comprising:
receiving, by the ledger circuitry and via the distributed ledger, an indication of an actionable security event; and
performing an action based on the actionable security event.

3. The method of claim 1, wherein the distributed ledger is a permissioned distributed ledger.

4. The method of claim 1, wherein a first ledger node from the set of distributed ledger nodes uses a first consensus mechanism, wherein a second ledger node from the set of distributed ledger nodes uses a second consensus mechanism.

5. The method of claim 4, wherein the distributed ledger is a blockchain, wherein the blockchain comprises a first sidechain and a second sidechain, wherein the first sidechain comprises the first ledger node, wherein the second sidechain comprises the second ledger node.

6. The method of claim 1, further comprising:
receiving, by communications hardware, a record of activity related to the computer network; and
generating, by a machine learning model, a skimmed log based on the record of activity, wherein the indication of the security event comprises the skimmed log.

7. The method of claim 6, further comprising:
generating, by a language model, a formatted log based on the record of activity, wherein generating the skimmed log uses the formatted log as input to the machine learning model.

8. An apparatus for automatic distributed security logging, the apparatus comprising:
security agent circuitry configured to:
detect a security event related to a computer network;
logging circuitry configured to:
record an indication of the security event to a storage element belonging to the computer network,
wherein the security agent circuitry is further configured to determine an impact level and a time sensitivity of the security event; and
ledger circuitry configured to:
process the security event based on the impact level to produce a ledger security event,
select a number of distributed ledger nodes of a distributed ledger for consensus based on the impact level and the time sensitivity of the security event, and
broadcast an indication of the ledger security event to a set of distributed ledger nodes numbering at least the selected number of distributed ledger nodes, wherein the distributed ledger operates using a dynamic consensus model.

9. The apparatus of claim 8, wherein the ledger circuitry is further configured to:
receive, via the distributed ledger, an indication of an actionable security event; and
perform an action based on the actionable security event.

10. The apparatus of claim 8, wherein the distributed ledger is a permissioned distributed ledger.

11. The apparatus of claim 8, wherein a first ledger node from the set of distributed ledger nodes uses a first consensus mechanism, wherein a second ledger node from the set of distributed ledger nodes uses a second consensus mechanism.

12. The apparatus of claim 11, wherein the distributed ledger is a blockchain, wherein the blockchain comprises a first sidechain and a second sidechain, wherein the first sidechain comprises the first ledger node, wherein the second sidechain comprises the second ledger node.

13. The apparatus of claim 8, further comprising communications hardware configured to:
receive a record of activity related to the computer network,
wherein the security agent circuitry is further configured to generate, by a machine learning model, a skimmed log based on the record of activity, wherein the indication of the security event comprises the skimmed log.

14. The apparatus of claim 13, wherein the security agent circuitry is further configured to generate, by a language model, a formatted log based on the record of activity, wherein generating the skimmed log uses the formatted log as input to the machine learning model.

15. A computer program product for automatic distributed security logging, the computer program product comprising at least one non-transitory computer-readable storage medium storing program instructions that, when executed, cause a system to:
detect a security event related to a computer network;
record an indication of the security event to a storage element belonging to the computer network;
determine an impact level and a time sensitivity of the security event;
process the security event based on the impact level to produce a ledger security event;
select a number of distributed ledger nodes of a distributed ledger for consensus based on the impact level and the time sensitivity of the security event; and
broadcast an indication of the ledger security event to a set of distributed ledger nodes numbering at least the selected number of distributed ledger nodes, wherein the distributed ledger operates using a dynamic consensus model.

16. The computer program product of claim 15, further comprising additional program instructions that, when executed, cause the system to:
receive, via the distributed ledger, an indication of an actionable security event; and
perform an action based on the actionable security event.

17. The computer program product of claim 15, wherein the distributed ledger is a permissioned distributed ledger.

18. The computer program product of claim 15, wherein a first ledger node from the set of distributed ledger nodes uses a first consensus mechanism, wherein a second ledger node from the set of distributed ledger nodes uses a second consensus mechanism.

19. The computer program product of claim 18, wherein the distributed ledger is a blockchain, wherein the blockchain comprises a first sidechain and a second sidechain, wherein the first sidechain comprises the first ledger node, wherein the second sidechain comprises the second ledger node.

20. The computer program product of claim 15, further comprising additional program instructions that, when executed, cause the system to:
receive a record of activity related to the computer network; and
generate, by a machine learning model, a skimmed log based on the record of activity, wherein the indication of the security event comprises the skimmed log.
